(19) United States
(12) Patent Application Publication
(10) Pub. No.: US 2015/0065202 A1
(43) Pub. Date: Mar. 5, 2015

(54) ELECTRONIC DEVICE INCLUDING OPENABLE COVER AND METHOD OF OPERATING THE SAME

(71) Applicant: Samsung Electronics Co., Ltd., Gyeonggi-do (KR)

(72) Inventors: Jin-Jung Lee, Seoul (KR); Seong-Eun Kim, Seoul (KR); Won-Bae Lim, Seoul (KR)

(21) Appl. No.: 14/476,668

(22) Filed: Sep. 3, 2014

(30) Foreign Application Priority Data
Sep. 3, 2013 (KR) 10-2013-0105577

(51) Int. Cl. H04M 1/725; H04M 1/02

(52) U.S. Cl. CPC H04M 1/7258; H04M 1/0245
USPC 455/566; 455/575.8

(57) ABSTRACT

An electronic device including a cover device that can open and close a screen using a cover and a method of operating the same can be provided. The method of operating an electronic device including an openable cover includes receiving a call. The method also includes performing a function of the call when a pressing of at least one external button exposed to an outside is detected in a state in which the cover is closed.

### PRIORITY

The present application is related to and claims priority under 35 U.S.C. §119(a) of a Korean patent application filed in the Korean Intellectual Property Office on Sep. 3, 2013 and assigned Serial No. 10-2013-0105577, the entire disclosure of which can be hereby incorporated by reference.

### TECHNICAL FIELD

The present disclosure relates to an electronic device including a cover device that arranged to open and close a screen using a cover.

### BACKGROUND

Due to the development of an electronic communication industry, as electronic devices are widely used, the electronic device has become an important means for transferring information. Further, due to the development of a Graphic User Interface (GUI) system, a display of a good quality can be applied to the electronic device.

In general, an electronic device can include a display, and the electronic device displays various information through the display. Nowadays, as a large screen of a high resolution can be preferred, a display that satisfies this can be applied to the electronic device.

### SUMMARY

To address the above-discussed deficiencies, it is a primary object to provide an electronic device and a method of operating the same that can easily control connection or termination (such as interruption) of an incoming call in a state in which a cover is closed.

In a first example, a method of operating an electronic device including an openable cover includes receiving a call. The method also includes performing a function of the call when a pressing of at least one external button exposed to the outside is detected in a state in which the cover can be closed.

In a second example, a call processing method can display information about a call through a partial display area of a screen corresponding to a window of a cover, even if the cover is closed, and a call can be connected or terminated in response to a pressing of an external button (such as a power button) exposed to the outside and thus user convenience can be enhanced.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure and its advantages, reference is now made to the following description taken in conjunction with the accompanying drawings, in which like reference numerals represent like parts;

FIGS. 1 to 3 are perspective views illustrating examples of coupling states of an electronic device and a cover device according to this disclosure;

FIG. 4 is a block diagram illustrating an example configuration of an electronic device according to this disclosure;

FIG. 5 is a block diagram illustrating an example configuration of hardware according to this disclosure;

FIG. 6 is a block diagram illustrating an example configuration of a programming module according to this disclosure;

FIG. 7 is a block diagram illustrating an example configuration of a call processing module according to this disclosure;

FIG. 8 is a flowchart illustrating an example call processing process according to this disclosure;

FIGS. 9A and 9B are flowcharts illustrating an example call processing process according to this disclosure;

FIG. 10 is a block diagram illustrating an example configuration of a button function module according to this disclosure;

FIG. 11 is a flowchart illustrating an example input processing process according to this disclosure;

FIG. 12 illustrates an example screen of an electronic device according to this disclosure; and

FIG. 13 is a diagram illustrating an example use example according to this disclosure.

### DETAILED DESCRIPTION

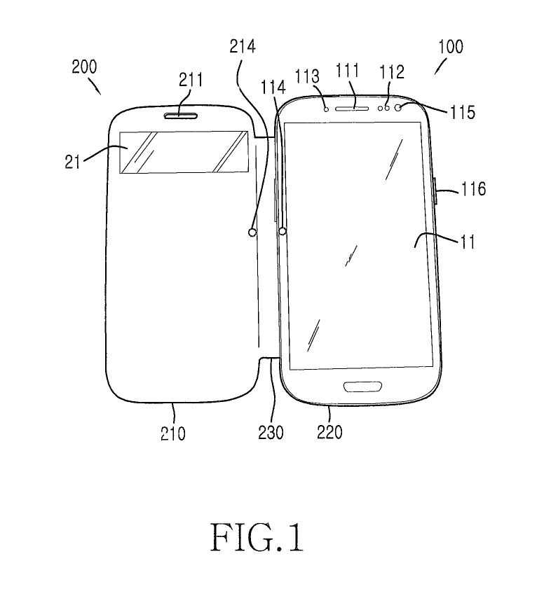

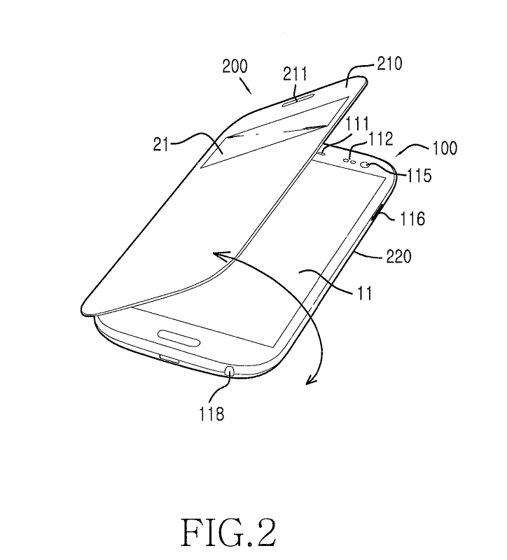

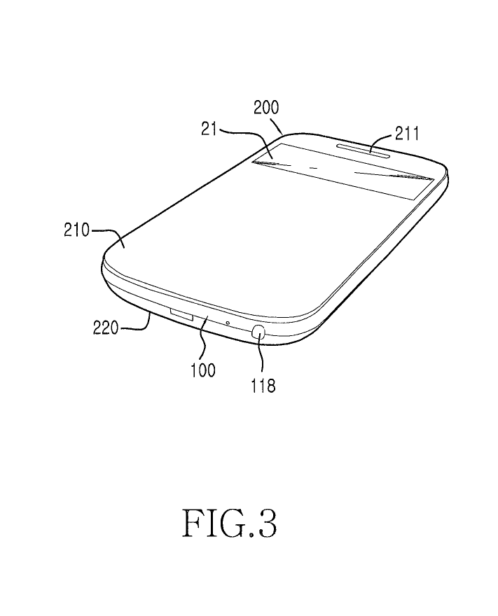

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of embodiments of the disclosure as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims can be not limited to their dictionary meanings, but, are merely used to enable a clear and consistent understanding of the disclosure. Accordingly, it should be apparent to those skilled in the art that the following description of embodiments of the present disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, can occur in amounts that do not preclude the effect the characteristic was intended to provide.

FIGS. 1 to 3 are perspective views illustrating examples of coupling states of an electronic device and a cover device according to this disclosure.

Referring to FIGS. 1 to 3, a cover device 200 can have a second cover 220 that can form a rear surface of an electronic device 100. The cover device 200 can have a first cover 210 that can open and close a front surface of the electronic device 100 in a rotation method. At a front surface of the electronic device 100, a touch screen 11, a speaker 111, a proximity sensor, or a gesture sensor 112, a Red, Green, and Blue (RGB) sensor 113, a hall sensor 114, and a camera 115 can be disposed. The cover device 200 can include a connection portion 230 that connects the first cover 210 and the second cover 220. The connection portion 230 can cover a side surface (such as a surface that connects a front surface and a rear surface) of the electronic device 100. The first cover 210 of the cover device 200 can have a through hole 211 corresponding to the speaker 111 of the electronic device 100. The first cover 210 of the cover device 200 can have a magnet 214 corresponding to the hall sensor 114 of the electronic device 100. The first cover 210 of the cover device 200 can have a transparent window 21.

The electronic device 100 can determine opening and closing of the first cover 210 of the cover device 200 with detection information through at least one sensor (such as the proximity sensor, the gesture sensor 112, or the hall sensor 114). For example, when the first cover 210 of the cover device 200 is closed, the hall sensor 114 of the electronic device 100 can be excited by the magnet 214 of the first cover 210. The electronic device 100 can control (such as convert a display mode) to display a screen according to opening and closing of the first cover 210 of the cover device 200. The electronic device 100 can set a first area (such as a display area corresponding to the window 21 of the first cover 210) of the screen 11 to a display area according to closing of the first cover 210. The electronic device 100 can set a second area (such as an entire area) of the screen 11 to a display area according to opening of the first cover 210. The electronic device 100 can display corresponding contents in a preset display area according to occurrence of an event (such as pressing of a power button 116 or separation of a stylus 118). For example, the electronic device 100 can display various notification information (such as a present time, a battery residual quantity, or a communication environment state) in a preset display area in response to pressing of the external button (such as the power button 116). The electronic device 100 can display notification information such as message reception, call reception, or alarm in a preset display area. The electronic device 100 can adjust touch sensitivity according to opening and closing of the first cover 210. For example, when the first cover 210 is closed, the electronic device 100 can adjust touch sensitivity and execute a hovering touch mode. In a state in which the first cover 210 can be closed, a user can perform a touch gesture (such as a single touch, a multi touch, or flicking) for an operation control in a surface of the window 21.

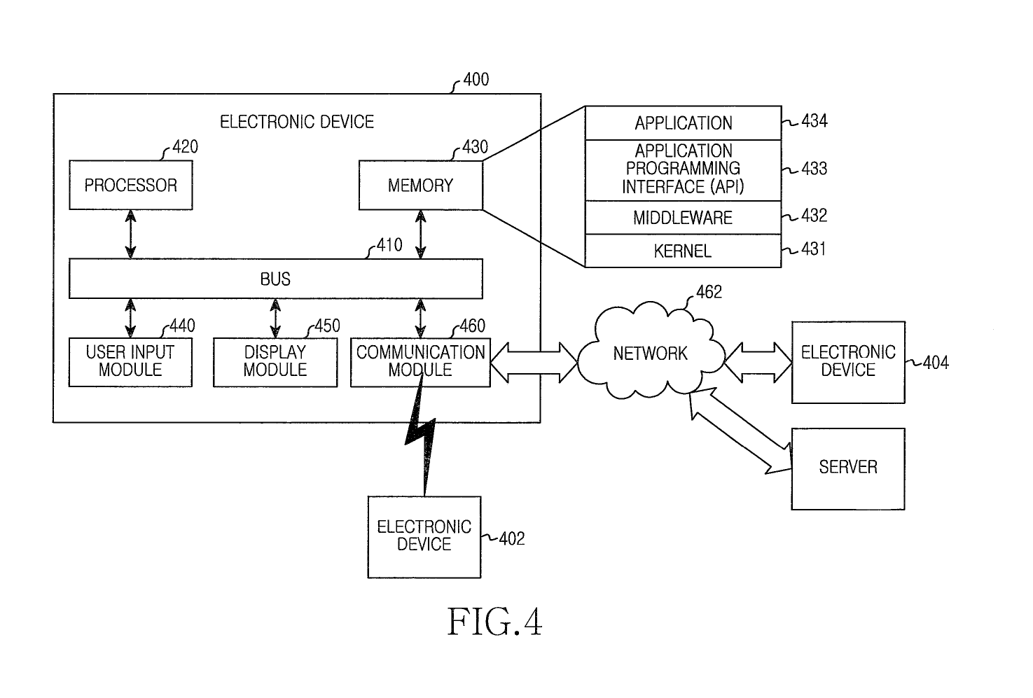

FIG. 4 is a block diagram illustrating an example configuration of an electronic device according to this disclosure.

The electronic device according to this disclosure can be a device having a communication function. For example, the electronic device can include a smart phone, a tablet personal computer (tablet PC), a mobile phone, an audiovisual phone, an e-book reader, a desktop PC, a laptop PC, a netbook computer, a Personal Digital Assistant (PDA), a portable multimedia player (PMP), a Moving Picture Experts Group layer-3 (MP3) player, a mobile medical device, a camera, and a wearable device (such as at least one of a Head-Mounted-Device (HMD) such as electronic glasses, electronic clothes, an electronic bracelet, an electronic necklace, electronic accessories, or a smart watch).

In an embodiment, the electronic device can be a smart home appliance having a communication function. The smart home appliance can include at least one of, for example, a television, a Digital Video Disk (DVD) player, an audio device, a refrigerator, an air-conditioner, a cleaner, an oven, a microwave oven, a washing machine, an air cleaner, a set-top box, a television box (such as Samsung HomeSync™, Apple TV™, or Google TV™), game consoles, an electronic dictionary, a camcorder, and an electronic frame.

In an embodiment, the electronic device can include at least one of various medical devices (such as a Magnetic Resonance Angiography (MRA) device, a Magnetic Resonance Imaging (MRI) device, a Computed Tomography (CT) device, a scanning device, and an ultrasonic wave device), a navigation device, a Global Positioning System (GPS) receiver, an Event Data Recorder (EDR), a Flight Data Recorder (FDR), a vehicle infotainment device, a ship electronic equipment (such as a navigation device and a gyro compass for a ship), avionics, and a security device.

In an embodiment, the electronic device can include at least one of a portion of furniture or a building/structure having a communication function, an electronic board, an electronic signature receiving device, a projector, or various measuring devices (such as measuring devices for water supply, electricity, gas, or electric wave). The electronic device can also be at least one combination of the foregoing various devices. Further, it will become apparent to a person of common skill in the art that the electronic device may not be limited to the foregoing devices.

Referring to FIG. 4, an electronic device 400 can include a bus 410, a processor 420, a memory 430, a user input module 440, a display module 450, and a communication module 460.

The bus 410 can be a circuit that connects the foregoing elements and that transfers communication (such as a control message) between the foregoing elements.

The processor 420 can receive an instruction from the foregoing other elements (such as the memory 430, the user input module 440, the display module 450, and the communication module 460) through, for example, the bus 410, decode the received instruction, and execute a calculation or a data processing according to the decoded instruction.

The memory 430 can store an instruction or data received from the processor 420 or other elements (such as the user input module 440, the display module 450, and the communication module 460) or generated by the processor 420 or other elements. The memory 430 can include programming modules such as a kernel 431, middleware 432, an application programming interface (API) 433, or an application 434. The foregoing respective programming module can be formed with software, firmware, hardware, or a combination of at least two thereof.

The kernel 431 can control or manage system resources (such as the bus 410, the processor 420, or the memory 430) used for executing an operation or a function implemented in the remaining programming modules, for example, the middleware 432, the API 433, or the application 434. Further, the kernel 431 can provide an interface that accesses to an individual element of the electronic device 400 in the middleware 432, the API 433, or the application 434 to control or manage the individual element.

The middleware 432 can function as an intermediary that enables the API 433 or the application 434 to communicate with the kernel 431 to transmit and receive data. Further, the middleware 432 can perform load balancing of a work request using a method of aligning a priority that can use a system resource (such as the bus 410, the processor 420, or the memory 430) of the electronic device 400 to, for example, at least one application of the (plurality of) applications 434 in relation to work requests received from the (plurality of) applications 434.

The API 433 can be an interface in which the application 434 can control a function in which the kernel 431 or the middleware 432 provides and can include at least one interface or function for, for example, file control, window control, image processing, or character control.

The user input module 440 can receive an input of an instruction or data from a user and transfer the instruction or the data to the processor 420 or the memory 430 through the bus 410. The display module 450 can display a picture, an image, or data to the user.

The communication module 460 can connect communication between another electronic device 402 and the electronic device 400. The communication module 460 can support a predetermined short range communication protocol (such as Wireless fidelity (Wifi), Bluetooth (BT), Near Field Communication (NFC), or communication using a predetermined network 462 (such as Internet, a Local Area Network (LAN), a Wide Area Network (WAN), a telecommunication network, a cellular network, a satellite network, or Plain Old Telephone Service (POTS)). The electronic devices 402 and 404 each can be the same (such as the same type) device as the electronic device 400 or can be a device different (such as different type) from the electronic device 400.

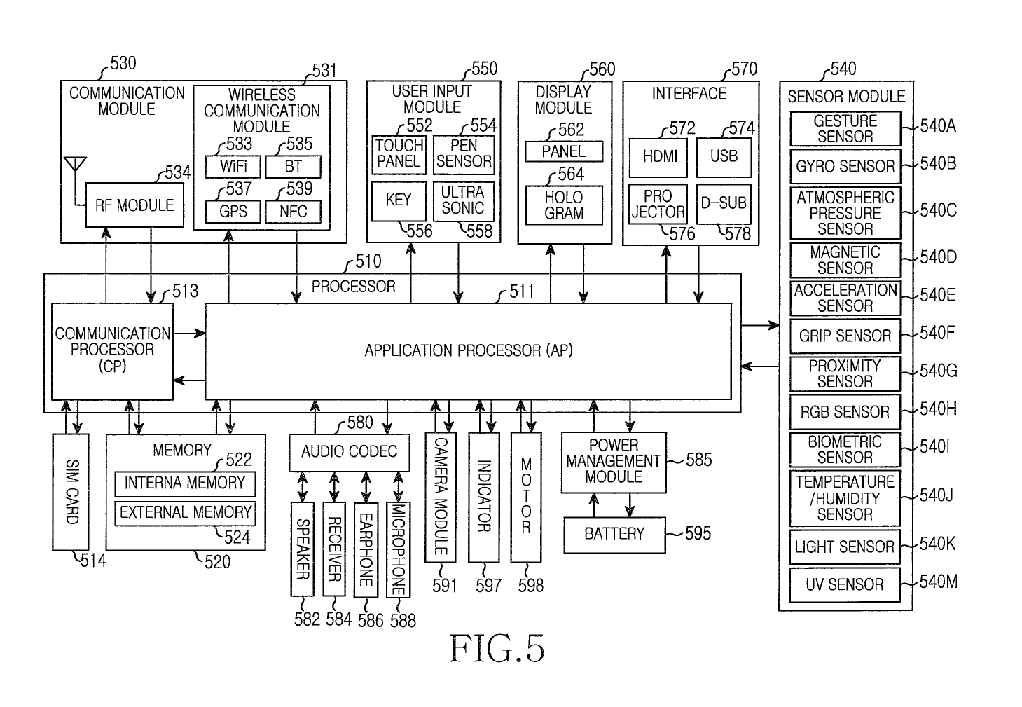

FIG. 5 is a block diagram illustrating an example configuration of hardware according to this disclosure. Hardware 500 can be, for example, the electronic device 400 of FIG. 4.

Referring to FIG. 5, the hardware 500 can include at least one processor 510, a Subscriber Identification Module (SIM) card 514, a memory 520, a communication module 530, a sensor module 540, a user input module 550, a display module 560, an interface 570, an audio codec 580, a camera module 591, a power management module 595, a battery 596, an indicator 597, and a motor 598.

The processor 510 (such as the processor 420 of FIG. 4) can include at least one application processor (AP) 511 or at least one communication processor (CP) 513. The processor 510 can be, for example, the processor 420 of FIG. 4. In FIG. 5, the AP 511 and the CP 513 can be included within the processor 510, but the AP 511 and the CP 513 can be included within different IC packages, respectively. The AP 511 and the CP 513 can be included within an IC package.

The AP 511 can drive an operation system or an applied program to control a plurality of hardware or software elements connected to the AP 511 and can perform various data processing and calculation including multimedia data. The AP 511 can be implemented with, for example, a System on Chip (SoC). The processor 510 can further include a Graphic Processing Unit (GPU).

The CP 513 can perform a function of managing a data link in communication between an electronic device (such as the electronic device 400) including the hardware 500 and other electronic devices connected by a network and a function of converting a communication protocol. The CP 513 can be implemented with, for example, a SoC. The CP 513 can perform at least a portion of a multimedia control function. The CP 513 can perform identification and authentication of a terminal within a communication network using, for example, a subscriber identification module (such as the SIM card 514). Further, the CP 513 can provide services such as audio dedicated communication, audiovisual communication, a text message, or packet data to the user.

Further, the CP 513 can control data transmission and reception of the communication module 530. In FIG. 5, elements of the CP 513, the power management module 595, or the memory 520 can be elements separate from the AP 511, but the AP 511 can include at least a portion (such as the CP 513) of the foregoing elements.

The AP 511 or the CP 513 can load and process an instruction or data received from at least one of a non-volatile memory connected to each thereof or another element in a volatile memory. Further, the AP 511 or the CP 513 can store data received from at least one of other elements or generated by at least one of other elements at a non-volatile memory.

The SIM card 514 can be a card that implements a subscriber identification module and can be inserted into a slot formed at a specific location of an electronic device. The SIM card 514 can include intrinsic identification information (such as Integrated Circuit Card Identifier (ICCID) or subscriber information (such as International Mobile Subscriber Identity (IMSI).

The memory 520 can include a built-in memory 522 or a removable memory 524. The memory 520 can be, for example, the memory 430 of FIG. 4. The built-in memory 522 can include at least one of, for example, a volatile memory (such as a Dynamic RAM (DRAM), a Static RAM (SRAM), a Synchronous Dynamic RAM (SDRAM)), or a non-volatile memory (such as a One Time Programmable ROM (OTPROM), a Programmable ROM (PROM), an erasable and programmable ROM (EPROM), an Electrically Erasable and Programmable ROM (EEPROM), a mask ROM, a flash ROM, a NAND flash memory, and a NOR flash memory). The built-in memory 522 can have a form of a Solid State Drive (SSD). The removable memory 524 can further include a flash drive, for example, a Compact Flash (CF), secure digital (SD), Micro Secure Digital (Micro-SD), Mini Secure Digital (Mini-SD), Extreme Digital (xD), or a memory stick.

The communication module 530 can include a wireless communication module 531 or a Radio Frequency (RF) module 534. The communication module 530 can be, for example, the communication module 460 of FIG. 4. The wireless communication module 531 can include, for example, a WiFi module 533, a Bluetooth (BT) module 535, a GPS module 537, or a NFC module 539. For example, the wireless communication module 531 can provide a wireless communication function using an RE Additionally or alternatively, the wireless communication module 531 can include a network interface (such as a LAN card) or a modem that connects the hardware 500 to a network (such as Internet, a LAN, a WAN, a telecommunication network, a cellular network, a satellite network, or a POTS).

The RF module 534 can perform transmission and reception of data, for example, transmission and reception of an RF signal or a called electronic signal. The RF module 534 can also include, for example, a transceiver, a Power Amp Module (PAM), a frequency filter, or a Low Noise Amplifier (LNA). Further, the RF module 534 can further include a component, for example, a conductor or a conductive wire to transmit and receive electromagnetic waves on free space in wireless communication.

The sensor module 540 can include at least one of, for example, a gesture sensor 540A, a proximity sensor 540B, a grip sensor 540C, a gyro sensor 540D, an acceleration sensor 540E, a terrestrial magnetic sensor 540F, an atmospheric pressure sensor 540G, a temperature/humidity sensor 540H, a hall sensor 540I, an RGB sensor 540J, an illumination sensor 540K, a bio sensor, an Ultra Violet (UV) sensor 540M, or a stylus detector. The sensor module 540 can measure a physical quantity or detect an operation state of an electronic device and can convert measured or detected information to an electric signal. Additionally or alternatively, the sensor module 540 can include, for example, an E-nose sensor, an electromyography sensor (EMG sensor), an electroencephalogram sensor (EEG sensor), an electrocardiogram sensor (ECG sensor), or a fingerprint sensor. The sensor module 540 can further include a control circuit that can control at least one sensor belonging to the inside.

The user input module 550 can include a touch panel 552, a (digital) pen sensor 554, a key 556, or an ultrasonic wave input device 558. The user input module 550 can be, for example, the user input module 440 of FIG. 4. The touch panel 552 can recognize a touch input with at least one method of, for example, a capacitive, resistive, infrared ray, or ultrasonic wave method. Further, the touch panel 552 can further include a controller. When the touch panel 552 is a capacitive type touch panel, the touch panel 552 can perform a direct touch and proximity recognition. The touch panel 552 can further include a tactile layer and provide a haptic reaction to the user.

The (digital) pen sensor 554 can be implemented using at least one method of a capacitive, resistive, infrared ray, or ultrasonic wave method, which can be the same method as and a method similar to, for example, reception of a touch input of the user or using a separate recognition sheet. As the key 556, for example, a keypad or a touch key can be used. The ultrasonic wave input device 558 can be a device that can determine data by detecting a sound wave with a microphone (such as a microphone 588) in a terminal through a pen that generates an ultrasonic wave signal and can perform wireless recognition. The hardware 500 can receive a user input from an external device (such as a network, a computer, or a server) connected to the communication module 530 using the communication module 530.

The display module 560 can include a panel 562 or a hologram 564. The display module 560 can be, for example, the display module 450 of FIG. 4. The panel 562 can be, for example, a Liquid Crystal Display (LCD) or an Active Matrix Organic Light Emitting Diode (AMOLED). The panel 562 can be implemented with, for example, a flexible, transparent, or wearable method. The panel 562 and the touch panel 552 can be formed in a module. The hologram 564 can show a stereoscopic image in the air using interference of light. The display module 560 can further include a control circuit that controls the panel 562 or the hologram 564.

The interface 570 can include, for example, a High-Definition Multimedia Interface (HDMI) 572, a Universal Serial Bus (USB) 574, a projector 576, or a D-Subminiature (D-SUB) 578. Additionally or alternatively, the interface 570 can include, for example, Secure Digital (SD)/Multi-Media Card (MMC) or Infrared Data Association (IrDA).

The audio codec 580 can convert a sound and an electronic signal in two-ways. The audio codec 580 can convert sound information input or output through, for example, a speaker 582, a receiver 584, an earphone 586, or a microphone 588.

The camera module 591 can be a device that can photograph an image and a moving picture and can include at least one image sensor (such as a front surface lens or a rear surface lens), an image signal processor (ISP), or a flash light emitting diode (LED) according to an exemplary embodiment.

The power management module 595 can manage power of the hardware 500. The power management module 595 can also include, for example, a power management integrated circuit (PMIC), a charger integrated circuit (charge IC), or a battery fuel gauge.

The PMIC can be mounted within, for example, an integrated circuit or a SoC semiconductor. A charging method can be classified into a wired method and a wireless method. The charge IC can charge a battery and prevent an overvoltage or an overcurrent from being injected from a charging device. The charge IC can include a charge IC for at least one of a wired charge method and a wireless charge method. The wireless charge method can include, for example, a magnetic resonance method, a magnetic induction method, or an electromagnetic wave method and can add an additional circuit, for example, a circuit such as a coil loop, a resonant circuit, and a rectifier for wireless charge.

The battery gauge can measure, for example, a residual quantity of a battery 596 and a voltage, a current, or a temperature while charging. The battery 596 can generate electricity to supply power and can be, for example, a rechargeable battery.

An indicator 597 can display a specific state, for example, a booting state, a message state, or a charge state of the hardware 500 or a portion (such as the AP 511) thereof. A motor 598 can convert an electrical signal to a mechanical vibration.

A micro control unit (MCU) can control the sensor module 540.

The hardware 500 can include a processing device (such as GPU) for supporting a mobile TV. The processing device for supporting the mobile TV can process media data according to a specification of, for example, digital multimedia broadcasting (DMB), digital video broadcasting (DVB), or media flow.

Names of the foregoing elements of hardware according to this disclosure can be changed according to a kind of an electronic device. Hardware can also include at least one of the foregoing elements and can be formed in a form in which some elements can be omitted, or can further include additional elements. Further, when some of elements of hardware according to this disclosure are coupled to form an entity, the entity can equally perform a function of corresponding elements before coupling.

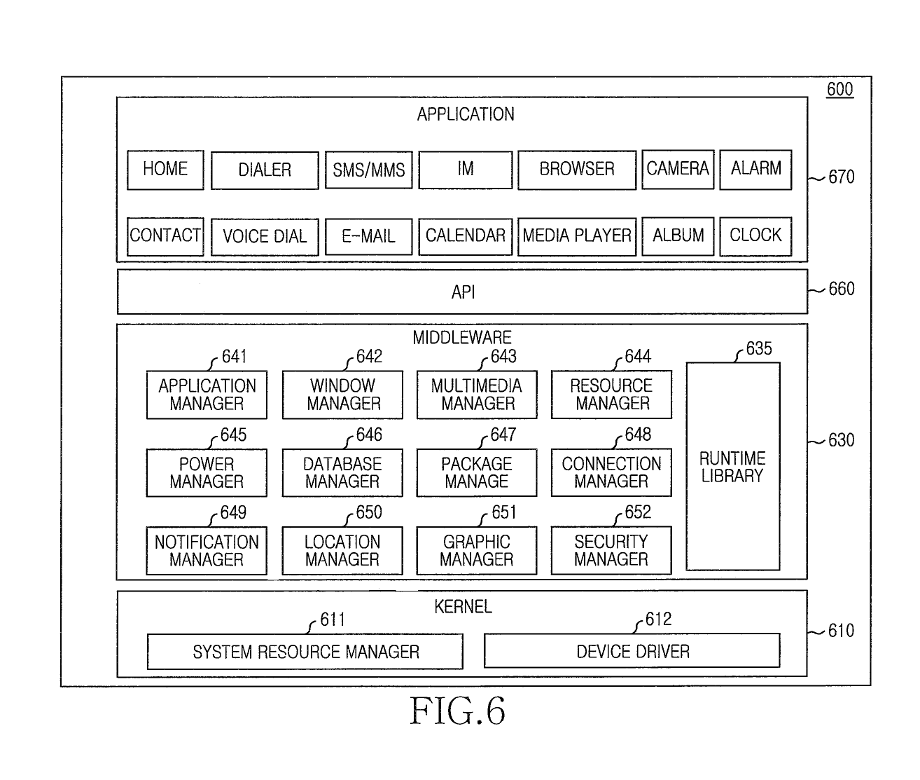

FIG. 6 is a block diagram illustrating an example configuration of a programming module according to this disclosure.

A programming module 600 can be included (such as stored) in the electronic device 500 (such as the memory 520) of FIG. 5. At least a portion of the programming module 600 can be formed with software, firmware, hardware, or a combination of at least two thereof. The programming module 600 can include an operation system (OS) implemented in hardware (such as the hardware 500) to control a resource related to the electronic device (such as the electronic device 500) or various applications (such as an application 670) to be driven in the operation system. For example, the operation system can be Android, iOS, Windows, Symbian, Tizen, or Bada.

Referring to FIG. 6, the programming module 600 can include a kernel 610, middleware 630, an application programming interface (API) 660, and the application 670.

The kernel 610 (such as the kernel 431) can include a system resource manager 611 and a device driver 612. The system resource manager 611 can include, for example, a process management unit, a memory management unit, or a file system management unit. The system resource manager 611 can perform the control, allocation, or recovery of a system resource. The device driver 612 can include, for example, a display driver, a camera driver, a Bluetooth driver, a sharing memory driver, a universal serial bus (USB) driver, a keypad driver, a WiFi driver, or an audio driver. Further, the device driver 612 can include an inter-process communication (IPC) driver.

In order to provide a function in which the application 670 commonly requires, the middleware 630 can include a plurality of previously implemented modules. Further, in order to enable the application 670 to efficiently use a limited system resource within the electronic device, the middleware 630 can provide a function through the API 660. For example, as shown in FIG. 6, the middleware 630 (such as the middleware 432) can include at least one of a run-time library 635, an application manager 641, a window manager 642, a multimedia manager 643, a resource manager 644, a power manager 645, a database manager 646, a package manager 647, a connectivity manager 648, a notification manager 649, a location manager 650, a graphic manager 651, or a security manager 652.

In order to add a new function through a programming language while, for example, the application 670 can be being executed, the run-time library 635 can include a library module in which a compiler uses. The run-time library 635 can perform a function of an input and output, memory management, or an arithmetic function.

The application manager 641 can manage a life cycle of at least one of, for example, the applications 670. The window manager 642 can manage a graphical user interface (GUI) resource using on a screen. The multimedia manager 643 can grasp a format necessary for reproduction of various media files and perform encoding or decoding of a media file using a codec appropriate to a corresponding format. The resource manager 644 can manage a resource such as a source code, a memory, or storage space of at least one of the applications 670.

The power manager 645 can manage a battery or a power source by operating together with a Basic Input/Output System (BIOS) and can provide power information necessary for operation. The database manager 646 can manage a database so as to generate, search for, or change the database to be used in at least one of the applications 670. The package manager 647 can manage installation or update of an application distributed in a package file form.

The connectivity manager 648 can manage wireless connection of, for example, WiFi or Bluetooth. The notification manager 649 can display or notify an event of a receiving message, appointment, and proximity notification with a method of not disturbing a user. The location manager 650 can manage location information of the electronic device. The graphic manager 651 can manage a graphic effect to be provided to a user or a user interface related thereto. The security manager 652 can provide a security function necessary for system security or user authentication. When the electronic device (such as the electronic device 400) has a phone function, the middleware 630 can further include a telephony manager for managing an audio dedicated communication or audiovisual communication function of the electronic device.

The middleware 630 can generate and use a new middleware module through a combination of various functions of the foregoing internal element modules. In order to provide differential functions, the middleware 630 can provide a specialized module based on an operation system type. Further, the middleware 630 can dynamically delete a portion of an existing element or can add a new element. Therefore, the middleware 630 can omit some of elements described herein, can further include other elements, or can be replaced with an element that performs a similar function and that has another name.

The API 660 (such as the API 433) can be a set of API programming functions and can be provided in another element according to an operation system. For example, in Android or IOS, an API set can be provided on a platform basis, and in Tizen, at least two API sets can be provided.

The application 670 (such as the application 434) can include, for example, a preload application or a third party application.

At least a portion of the programming module 600 can be implemented with an instruction stored at computer-readable storage media. When an instruction is executed by at least one processor (such as the processor 510), the at least one processor can perform a function corresponding to an instruction. The computer-readable storage media can be, for example, the memory 520. At least a portion of the programming module 600 can be implemented (such as executed) by, for example, the processor 510. At least a portion of the programming module 600 can include, for example, a module, a program, a routine, sets of instructions, or a process for performing at least one function.

Names of elements of a programming module (such as the programming module 600) according to this disclosure can be changed according to an operation system type. Further, a programming module can include at least one of the foregoing elements, can be formed in a form in which some elements can be omitted, or can further include additional elements.

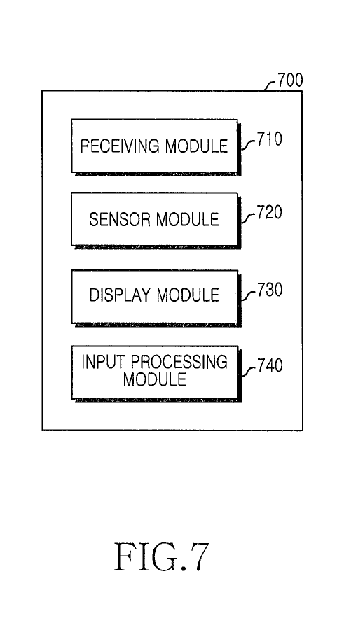

FIG. 7 is a block diagram illustrating an example configuration of a call processing module according to this disclosure.

Referring to FIG. 7, a call processing module 700 can include a receiving module 710, a sensor module 720, a display module 730, and an input processing module 740.

The receiving module 710 (such as the communication module 530) can receive a call,

The sensor module 720 (such as the sensor module 540) can determine whether the cover 200 is closed using at least one sensor (such as the proximity sensor 540B, the grip sensor 540C, the gyro sensor 540D, the acceleration sensor 540E, the terrestrial magnetic sensor 540F, the hall sensor 540I, and the illumination sensor 540K). For example, when the cover 200 is closed, the hall sensor 114 of the electronic device 100 can be excited by the magnet 214 of the cover 200. When the cover 200 is closed, the proximity sensor MOB of the electronic device 100 can respond thereto.

The display module 730 can display a call related interface image (such as sender information, a call reception button, or a call termination button) through a display area (such as a partial area of a screen) corresponding to the window 21 of the cover 200 in response to closing of the cover 200.

The input processing module 740 can perform a function of a call according to information about pressing of an external button (such as the power button 116). When information about pressing of the external button satisfies a stored reference, the input processing module 740 can perform a function of a call. The information about pressing of the external button can include the number of times of pressing and a pressing time (such as a pressing interval or a continuous pressing time) of the external button. The stored reference can include the preset number of times of pressing, the preset number of times of pressing pressed within a preset time, a preset continuous pressing time, or a combination of at least two thereof. Functions of various calls can be mapped and stored on a reference basis, and the input processing module 740 can determine a reference corresponding to information about pressing of the external button and perform a specific function of a call corresponding to the reference. The function of a call can include a connection (communication) of a call. The function of a call can include execution of a speaker phone. The function of a call can include termination of a call. The function of a call can include automatic response. For example, when the external button is pressed by the preset number of times (such as three times), but when a pressing time thereof does not exceed a preset time (such as two seconds), the input processing module 740 can connect or terminate an incoming call. Alternatively, when a time in which the external button is continuously pressed exceeds a preset time (such as two seconds), the input processing module 740 can connect or terminate an incoming call. The input processing module 740 can provide a user interface that enables a user to set the above-described reference and/or a function of a call mapped to the reference, and the user can set a function of an external button specialized to the user. Even if the cover 200 is closed, the external button can be exposed for use and can be disposed at the outside of the screen (such as a side portion of the electronic device 100).

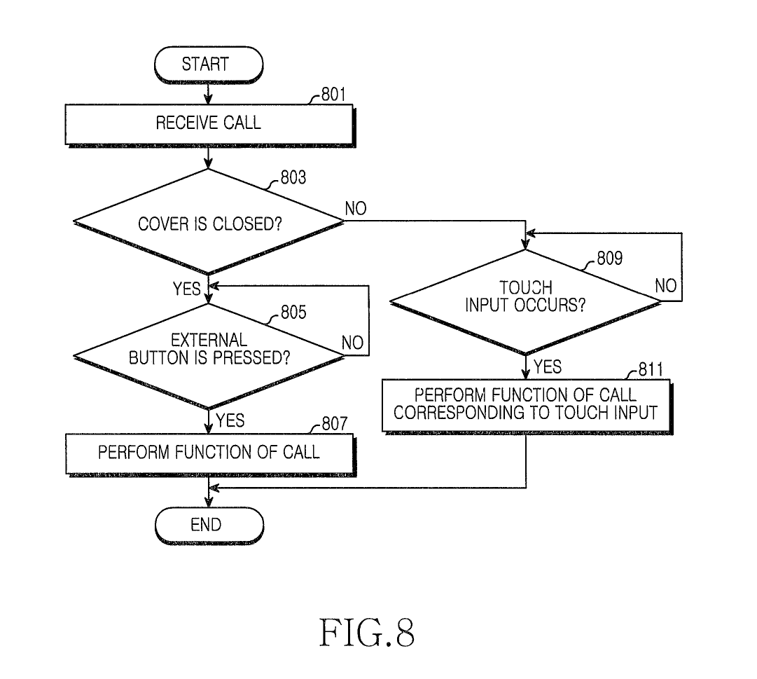

FIG. 8 is a flowchart illustrating an example call processing process according to this disclosure.

Referring to FIG. 8, the processor 510 (such as the receiving module 710) can receive a call in step 801.

The processor 510 (such as the sensor module 720) can determine whether the cover 200 is closed in step 803.

If the cover 200 is closed, the processor 510 (such as the input processing module 740) can determine whether an external button (such as the power button 116) is pressed in step 805.

If an external button is pressed, the processor 510 (such as the input processing module 740) can perform a function of a call (such as call connection or call termination) in step 807.

If the cover 200 is not closed at step 803, the processor 510 (such as the input processing module 740) can receive a call and determine whether a touch input occurs in response to opening of the cover 200 in step 809.

If a touch input occurs, the processor 510 (such as the input processing module 740) can perform a function of a call (such as a call connection or call termination) corresponding to the touch input in step 811.

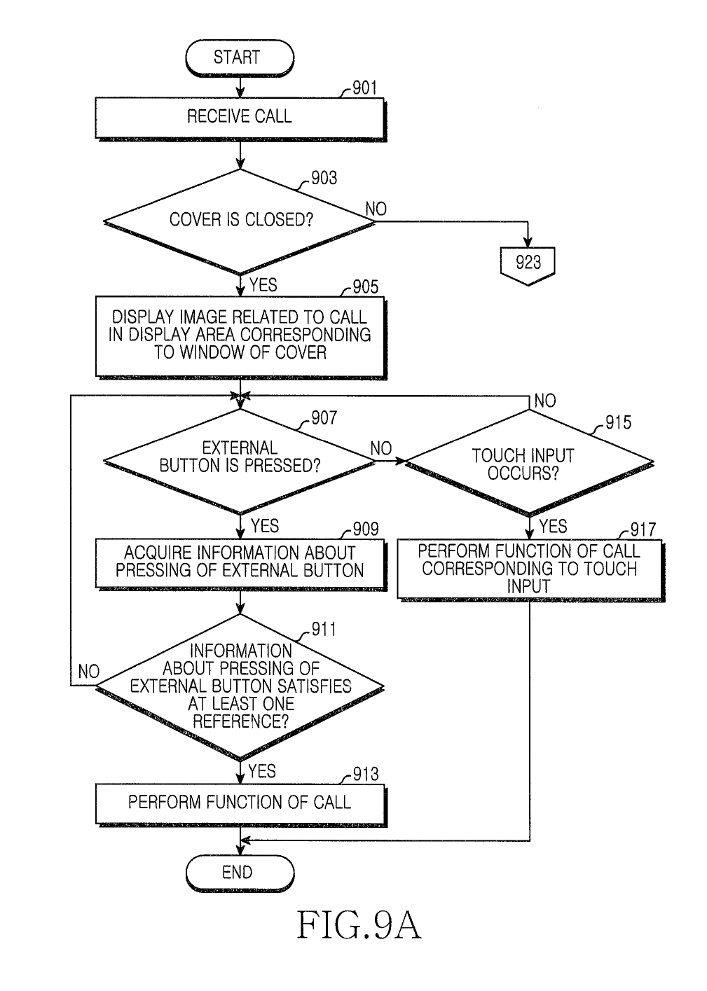

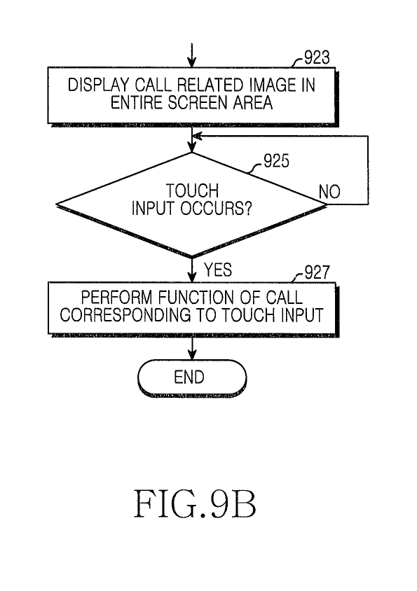

FIGS. 9A and 9B are flowcharts illustrating an example call processing process according to this disclosure.

Referring to FIGS. 9A and 9B, the processor 510 (such as the receiving module 710) can receive a call in step 901.

The processor 510 (such as the sensor module 720) can determine whether the cover 200 is closed in step 903.

If the cover 200 is closed, the processor 510 (such as the display module 730) can control to display an image (such as sender information, an incoming call reception button, and a call cancellation button) related to a call in a display area corresponding to a window of the cover 200 in response to closing of the cover 200 in step 905.

The processor 510 (such as the input processing module 740) can determine whether the external button is pressed in step 907.

If the external button is pressed, the processor 510 (such as the input processing module 740) can acquire information (such as the number of times of pressing and a pressing time) about pressing of the external button in step 909.

The processor 510 (such as the input processing module 740) can determine whether the information about pressing of the external button satisfies at least one reference (such as the preset number of times of pressing, the preset number of times of pressing pressed within a preset time, a preset continuous pressing time, or a combination of at least two thereof) in step 911.

If information about pressing of the external button satisfies at least one reference, the processor 510 (such as the input processing module 740) can perform a function of a call (such as call connection or call termination) in step 913. If information about pressing of the external button does not satisfy at least one reference, the processor 510 (such as the input processing module 740) can perform again step 905. Functions of various calls can be mapped and stored on a reference basis, and the processor 510 (such as the input processing module 740) can determine a reference corresponding to information about pressing of the external button and perform a specific function of a call corresponding to the reference.

If the external button is not pressed at step 907, the processor 510 (such as the input processing module 740) can determine whether a touch input occurs in a call related image displayed through a display area corresponding to the window of the cover 200 in step 915. If a touch input does not occur in a call related image, the processor 510 (such as the input processing module 740) can perform again step 905.

If a touch input occurs in a call related image, the processor 510 (such as the input processing module 740) can perform a function of a call (such as call connection or call termination) corresponding to the touch input in step 917.

If the cover 200 is not closed at step 903, the processor 510 (such as the input processing module 740) can receive a call and can control to display a call related image in an entire screen area in response to opening of the cover 200 in step 923.

The processor 510 (such as the input processing module 740) can determine whether a touch input occurs in step 925.

If a touch input occurs in the call related image at step 925, the processor 510 (such as the input processing module 740) can perform a function of a call (such as call connection or call termination) corresponding to the touch input in step 927.

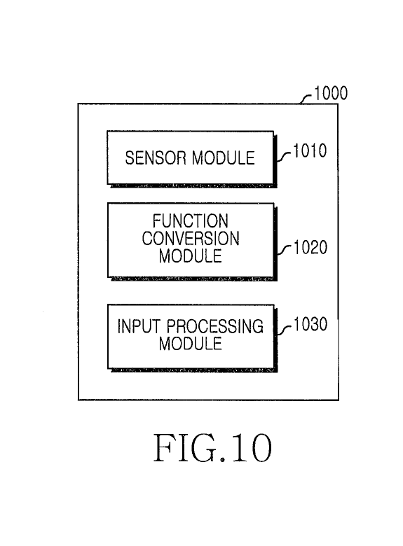

FIG. 10 is a block diagram illustrating an example configuration of a button function module according to this disclosure.

Referring to FIG. 10, a button function module 1000 can include a sensor module 1010, a function conversion module 1020, and a function processing module 1030.

The sensor module 1010 (such as the sensor module 540)) can determine whether the cover 200 is closed using at least one sensor.

The function conversion module 1020 can change functions (or a function group) of the external button (such as the power button 116) according to opening and closing of the cover 200. For example, the function conversion module 1020) can set a first function (such as a call receiving function) of the power button 116 in response to closing of the cover 200 and set a second function (such as a call termination function) of the power button 116 in response to opening of the cover 200.

The input processing module 1030 can detect pressing of the external button (such as the power button 116) and can perform a changed function according to opening and closing of the cover 200. The input processing module 1030 can acquire information (such as the number of times of pressing and a pressing time) about pressing of the external button (such as the power button 116), and when the information satisfies at least one reference, the input processing module 1030 can perform a changed function according to opening and closing of the cover 200.

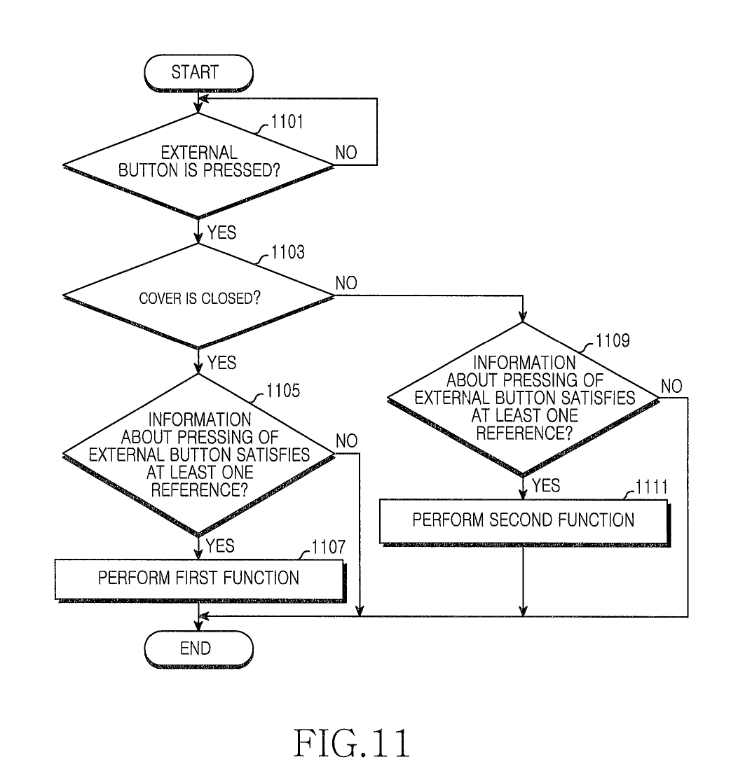

FIG. 11 is a flowchart illustrating an example input processing process according to this disclosure.

Referring to FIG. 11, the processor 510 (such as the input processing module 1030) can determine whether the external button (such as the power button 116) is pressed in step 1101.

If the external button (such as the power button 116) is pressed, the processor 510 (such as the sensor module 1010) can determine whether the cover 200 is closed using at least one sensor in response to pressing of the external button in step 1103.

The processor 510 can determine whether information about pressing of the external button satisfies at least one reference (such as the preset number of times of pressing, the preset number of times of pressing pressed within a preset time, or a preset continuous pressing time, or a combination of at least two thereof) in step 1105.

If information about pressing of the external button satisfies at least one reference, the processor 510 (such as the input processing module 1030) can perform a first function in step 1107.

If the cover 200 is not closed at step 1103, the processor 510 can determine whether the information about pressing of the external button satisfies at least one reference (such as the preset number of times of pressing, the preset number of times of pressing pressed within a preset time, or a preset continuous pressing time, or a combination of at least two thereof) in step 1109.

If the information about pressing of the external button satisfies at least one reference, the processor 510 (such as the input processing module 1030) can perform a second function in step 1111.

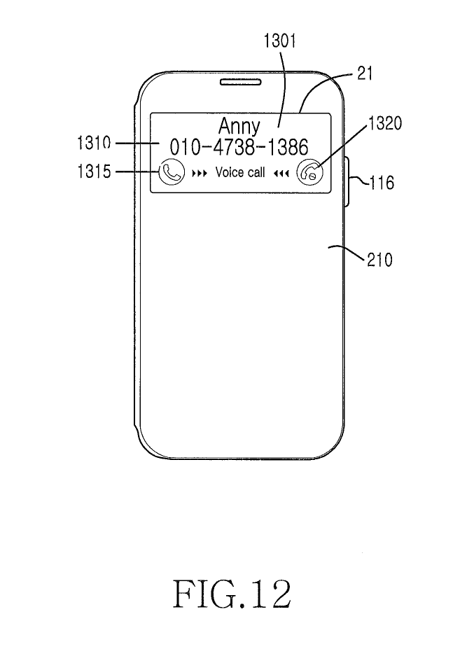

FIG. 12 illustrates an example screen of an electronic device according to this disclosure.

Referring to FIG. 12, in a state in which a cover (such as the first cover 210) is closed, when a call is received, the electronic device 100 can display a call reception related interface image 1301 through a display area corresponding to the window 21 of the first cover 210. The call reception related interface image 1301 can be shown through the window 21 of the cover 210. The call reception related interface image 1301 can include sender information (a name and a phone number) 1310, an incoming call reception button 1315, or a call cancellation button 1320. The electronic device 100 can receive a call (incoming call reception) in response to a touch gesture that moves the incoming call reception button 1315 to the right side. The electronic device 100 can terminate communication in response to a touch gesture that moves the call cancellation button 1320 to the left side. The electronic device 100 can allow or terminate communication in response to pressing of the power button 116 exposed to the outside.

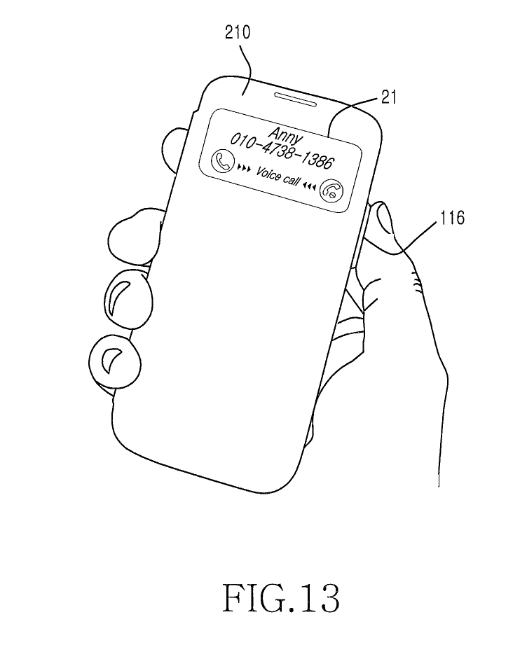

FIG. 13 is a diagram illustrating an example use example according to this disclosure.

Referring to FIG. 13, in a state in which a cover (such as the first cover 210) is closed, when a call is received, the electronic device 100 can display call related information through a display area corresponding to the window 21 of the first cover 210. The user can connect or terminate (reject) communication by pressing the power button 116 exposed to the outside. For example, when the user continuously presses two times the power button 116, the electronic device 100 can connect a call. When the user continuously presses three times the power button 116, the electronic device 100 can terminate a call and can perform an automatic response (such as automatic response message transmission).

In an embodiment, a method of operating the electronic device 100 including the openable cover 210 can include an operation of receiving a call and an operation of performing a function of a call, when a pressing of at least one external button (such as the power button 116) exposed to the outside is detected in a state in which the cover 210 is closed.

In an embodiment, in a state in which the openable cover 210 is closed, in a display area corresponding to the window 21 of the cover 210, an image of an incoming call can be displayed.

In an embodiment, in a state in which the cover 210 is closed, when a pressing of at least one external button (such as 116) is detected, an operation of performing a function of a call can include an operation of acquiring information about a pressing of at least one external button and an operation of performing a function of a call, when the information about the pressing of the at least one external button satisfies at least one reference.

In an embodiment, the information about pressing of the at least one external button can include at least one of the number of times of pressing or a pressing time (such as a pressing interval and a continuous pressing time).

In an embodiment, at least one reference can include the preset number of times of pressing, the preset number of times of pressing pressed within a preset time, a preset continuous pressing time, or a combination of at least two thereof.

In an embodiment, a function of a call can include connection or termination of a call.

In an embodiment, a function of a call can include a speaker phone or automatic response.

In an embodiment, at least one external button can be disposed at the outside of a screen.

In an embodiment, a method of operating the electronic device 100 including the openable cover 210 can include an operation of detecting whether at least one button (such as a power button) is pressed, an operation of determining whether the cover 210 is closed, and an operation of performing different functions according to an opening and a closing of the cover 210.

In an embodiment, an operation of performing each of the different functions according to the opening and the closing of the cover 210 can perform the different functions when information about a pressing of the at least one button satisfies at least one reference.

In an embodiment, the electronic device 100 can include a body including a display 11, a cover 210 that can cover or open the display 11 and that includes a window 21 that exposes a partial area of the display 11 when the display 11 is covered, at least one external button (such as the power button 116) disposed at an external appearance of the body and exposed to the outside regardless of opening and closing of the cover 210, at least one sensor housed in the body and that detects opening and closing of the cover 210, and the processor 510 housed in the body, and in a state in which the cover 210 is closed, when the processor 510 detects that at least one external button 116 is pressed, the processor 510 can perform a function of an incoming call.

In an embodiment, in a state in which the cover is closed, the processor 510 can control to display an image of a call in a partial area of the display 11 corresponding to the window 21 of the cover 210.

In an embodiment, the processor 510 can acquire information about pressing of at least one external button 116, and when the information about pressing of at least one external button (such as the power button 116) satisfies at least one reference, the processor 510 can perform a function of a call.

In an embodiment, the electronic device 100 can include a body including the display 11, a cover 210 that can cover or open the display 11 and that includes the window 21 that exposes a partial area of the display 11 when the display 11 is covered, at least one external button (such as the power button 116) disposed at an external appearance of the body and exposed to the outside regardless of opening and closing of the cover 210, at least one sensor (such as the sensor module 240) housed in the body and that detects opening and closing of the cover 210, and a processor 510 housed in the body, and when pressing of at least one external button is detected, the processor 510 can perform different functions according to opening and closing of the cover 210.

Methods according to exemplary embodiments described in claims and/or a specification of the present disclosure can be implemented in a form of hardware, software, or a combination thereof.

When implemented with software, a computer readable storage medium that stores at least one program (software module) can be provided. At least one program stored at a computer readable storage medium can be formed to execute by at least one processor within an electronic device. At least one program can include an instruction that enables the electronic device to execute methods according to exemplary embodiments described in claims and/or a specification of the present disclosure.

Such a program (software module, software) can be stored at a non-volatile memory including a random access memory (RAM), a flash memory, a read-only memory (ROM), an electrically erasable and programmable ROM (EEPROM), a magnetic disk storage device, a compact disk ROM (CD-ROM), a digital versatile disk (DVD), or an optical storage device of other form, and a magnetic cassette. Alternatively, the program can be stored at a memory formed with a combination of a portion or the entire thereof. Further, each constituent memory can be included in plural.

While the present disclosure has been particularly shown and described with reference to exemplary embodiments thereof, it will be understood by those skilled in the art that various changes in form and details can be made therein without departing from the spirit and scope of the present disclosure as defined by the appended claims.

What is claimed is:

1. A method for use in an electronic device, the method comprising:
receiving a call; and
performing a function corresponding to the call, when an input of at least one button exposed to the electronic device is detected in a state in which a cover is closed.

2. The method of claim 1, further comprising displaying an image of the call in a display area corresponding to a window of the cover in a state in which the cover is closed.

3. The method of claim 1, wherein the performing of the function corresponding to the call comprises:
acquiring information about a pressing of the at least one external button; and
performing a function of the call, when the information about the pressing of the at least one external button satisfies at least one reference.

4. The method of claim 3, wherein the information about the pressing of the at least one external button comprises at least one of a number of times of pressing or a pressing time.

5. The method of claim 3, wherein the at least one reference comprises one of a preset number of times of pressing, a preset number of times of pressings pressed within a preset time, a preset continuous pressing time, and a combination of at least two thereof.

6. The method of claim 1, wherein the function of the call comprises connection or termination of the call.

7. The method of claim 1, wherein the function of the call comprises a speaker phone or automatic response.

8. The method of claim 1, wherein the at least one external button is disposed at the outside of a screen.

9. A method of operating an electronic device comprising an openable cover, the method comprising:
detecting a pressing of at least one button;
determining whether the cover is closed; and
performing different functions according to whether the cover is closed.

10. The method of claim 9, wherein the performing of the different functions comprises performing each of the different functions, when information about the pressing of the at least one button satisfies at least one reference.

11. An electronic device, comprising:
a body comprising a display;
a cover configured to cover or open the display and comprising a window that exposes a partial area of the display when the display is covered;
at least one button disposed at an external appearance of the body and exposed to the outside of the electronic device regardless of an opening and a closing of the cover;
at least one sensor housed in the body and configured to detect the opening and the closing of the cover; and
a processor housed in the body,
wherein the processor is configured to perform a function correspond to an incoming call when an input of the at least one button is detected in a state in which the cover is closed.

12. The electronic device of claim 11, wherein the processor is configured to control to display an image of the call in a partial area of the display corresponding to a window of the cover in a state in which the cover is closed.

13. The electronic device of claim 11, wherein the processor is configured to acquire information about pressing of the at least one external button and perform a function of the call, when the information about a pressing of the at least one external button satisfies at least one reference.

14. The electronic device of claim 13, wherein the information about the pressing of the at least one external button comprises at least one of a number of times of pressing and a pressing time.

15. The electronic device of claim 13, wherein the at least one reference comprises one of a preset number of times of pressing, a preset number of times of pressings pressed within a preset time, a preset continuous pressing time, and a combination of at least two thereof.

16. The electronic device of claim 11, wherein the function of the call comprises connection or termination of the call.

17. The electronic device of claim 11, wherein the function of the call comprises a speaker phone or automatic response.

18. The electronic device of claim 11, wherein the at least one external button is disposed at the outside of a screen.

19. An electronic device, comprising:
a body comprising a display;
a cover configured to cover and open the display and comprising a window that exposes a partial area of the display when the display is covered;
at least one button disposed at an external appearance of the body and exposed to an outside of the electronic device regardless of an opening and a closing of the cover;
at least one sensor housed in the body and configured to detect the opening and the closing of the cover; and
a processor housed in the body,
wherein the processor is configured to perform different functions according to the opening and the closing of the cover when an input of the at least one button is detected.

20. The electronic device of claim 19, wherein the processor is configured to perform each of the different functions when information about pressing of the at least one external button satisfies at least one reference.
